(19) United States
(12) Patent Application Publication
(10) Pub. No.: US 2025/0243354 A1
(43) Pub. Date: Jul. 31, 2025

(54) POLYPROPYLENE COMPOSITIONS WITH IMPROVED WELD STRENGTH

(71) Applicant: Fina Technology, Inc., Houston, TX (US)

(72) Inventors: Peng Li, Sugar Land, TX (US); Fengkui Li, Houston, TX (US); Joachim Azzi, Houston, TX (US); Fabrice Dehais, Houston, TX (US); Susan Matthew, Pearland, TX (US)

(73) Assignee: Fina Technology, Inc., Houston, TX (US)

(21) Appl. No.: 19/039,335

(22) Filed: Jan. 28, 2025

Related U.S. Application Data
(60) Provisional application No. 63/626,460, filed on Jan. 29, 2024.

(51) Int. Cl. C08L 23/12

(52) U.S. Cl. CPC C08L 23/12; C08L 2205/025; C08L 2207/04; C08L 2207/20; C08L 2314/02; C08L 2314/06

(57) ABSTRACT

A polymer blend comprising (i) a primary polypropylene; and (ii) a secondary polypropylene, wherein the primary polypropylene comprises a Ziegler Natta polypropylene, a recycled polypropylene or combination thereof, and wherein the secondary polypropylene comprises a metallocene-catalyzed polypropylene.

### CROSS-REFERENCE TO RELATED APPLICATIONS

This application claims the benefit of U.S. provisional patent application Ser. No. 63/626,460 filed Jan. 29, 2024, and entitled “PROPYLENE COMPOSITIONS WITH IMPROVED WELD STRENGTH,” which is hereby incorporated herein by reference in its entirety for all purposes.

### STATEMENT REGARDING FEDERALLY SPONSORED RESEARCH OR DEVELOPMENT

Not applicable.

### TECHNICAL FIELD

The disclosure relates generally to polymer compositions. More particularly, the disclosure relates to polypropylene compositions. Still more particularly, the present disclosure relates to polypropylene compositions with improved injection molding performance.

### BACKGROUND

Polypropylene is a widely used plastic that has high modulus, high tensile strength, good heat resistance, and other favorable properties in the sold-state. Polypropylene injection molding is a procedure in which a thermoplastic polymer is heated above its melting point and then converted from a solid polymer to a melted fluid. This melted polypropylene is then injected into molds to get the desired shape of the parts. The purpose of molding is to produce more complex forms of polypropylene products, which cannot be made if the polypropylene were in its original form. One challenge in molding is the formation of weld lines.

A weld line and a meld line are both considered “flaws” formed when polymer flow fronts meet during an injection molding process. The difference between a weld line and a meld line is the angle at which the polymer fronts converge. A weld line forms when the polymer flow fronts meet at an angle of less than about 135 degrees while a meld line forms when the polymer flow fronts meet at an angle of greater than about 135 degrees. Meld lines are generally stronger and less visible than weld lines.

Weld lines generally occur in the region where two separated melt fronts initially recombine. The melt fronts may be separated by an obstacle, such as a core pin, or by a geometric feature, such as a boss or change in thickness. Also, weld lines can form when the part requires multiple injection locations or when jetting occurs due to an unrestricted gate injecting at a relatively high velocity. The bond formed by a weld line may not be as strong as the material itself, and as a result, weld lines can be potential weak points in the molded part, reducing its mechanical strength and potentially leading to part failure.

FIGS. 1A, 1B, 1C, and 1D depict steps in a process in which separated polymer melt fonts recombine. With reference to FIG. 1A, a polymer melt 10 is introduced to a cavity and follows in the direction indicated by flow lines 30. The polymer melt flow front 20 encounters an obstacle 40 which separates the polymer melt into two polymer melt flows. With reference to FIG. 1B, the polymer melt flow front 20 continues to flow past the obstacle 40 and forms weld lines 50 after the separated polymer melt flows initially interact at angle theta (0) which is less than about 135°. With reference to FIG. 1C, as the polymer melt flow front 20 continues, meld lines 60 form. during the melt flow of a polymer when encountering an obstacle in a cavity. The polymer melt flow front 10 continues until polymer melt fills the cavity and a mold containing both weld and meld lines is formed, FIG. 1D.

Functionally, weld lines can cause severe reductions in material strength. To complicate matters, the relationship between the weld line and the potential point of failure is not intuitive. After the weld line forms, it can shift due to multiple factors such as how the part is injected. Cosmetically, weld lines produce visible surface defects that degrade the part's perceived value with potential customers. Thus, there is an ongoing need to address the deficiencies associated with the presence of weld lines in molded articles.

### BRIEF SUMMARY OF THE DISCLOSURE

Disclosed herein is a polymer blend comprising (i) a primary polypropylene; and (ii) a secondary polypropylene, wherein the primary polypropylene comprises a Ziegler Natta polypropylene, a recycled polypropylene or combination thereof, and wherein the secondary polypropylene comprises a metallocene-catalyzed polypropylene.

Aspects described herein comprise a combination of features and characteristics intended to address various shortcomings associated with certain prior devices, systems, and methods. The foregoing has outlined rather broadly the features and technical characteristics of the disclosed aspects in order that the detailed description that follows may be better understood. The various characteristics and features described above, as well as others, will be readily apparent to those skilled in the art upon reading the following detailed description, and by referring to the accompanying drawings. It should be appreciated that the conception and the specific aspects disclosed may be readily utilized as a basis for modifying or designing other structures for carrying out the same purposes as the disclosed aspects. It should also be realized that such equivalent constructions do not depart from the spirit and scope of the principles disclosed herein.

### BRIEF DESCRIPTION OF THE DRAWINGS

For a detailed description of various exemplary aspects, reference will now be made to the accompanying drawings in which:

FIG. 1A schematically depicts the melt flow behavior of a polymer when encountering an obstacle in a cavity.

FIG. 1B schematically depicts the formation of weld lines during the melt flow of a polymer when encountering an obstacle in a cavity.

FIG. 1C schematically depicts the formation of meld lines during the melt flow of a polymer when encountering an obstacle in a cavity.

FIG. 1D schematically depicts a mold containing meld lines and weld lines.

FIG. 2 depicts a molded part prepared using the compositions of the present disclosure.

FIG. 3 is a bar graph of weld line strength for the indicated sample.

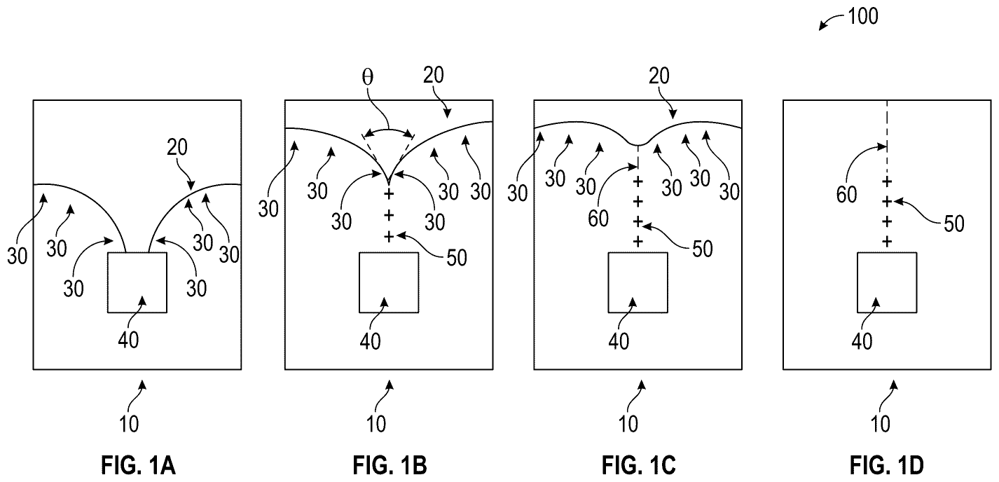

### DETAILED DESCRIPTION

Disclosed herein are polypropylene compositions that can form molded articles having improved mechanical properties. These propylene compositions are termed polypropylene compositions with improved mechanical properties and designated PPC. In one or more aspects, the PPC is used to form molded articles with weld lines that have increased strength when compared to a molded article prepared without a PPC.

Molded articles with weld lines formed from a PPC of the present disclosure may be characterized by one or more mechanical properties that are improved when compared to the mechanical properties of a molded article prepared with a non-PPC. For example, the strength of the molded article may be increased relative to an otherwise identical molded article formed using a non-PPC. In one or more aspects, a PPC of the present disclosure comprises a blend of (i) a primary polypropylene and (ii) a secondary polypropylene.

In an aspect, a primary polypropylene suitable for use in the PPC comprises a Ziegler Natta polypropylene, a recycled polypropylene (rPP) or combinations thereof. Herein a Ziegler Natta polypropylene refers to a polypropylene prepared using a Ziegler Natta catalyst. Ziegler Natta are catalysts are typically based on titanium and one or more organometallic aluminum compounds, such as triethylaluminum (C₂H₅)₃Al.

In one or more aspects, the Ziegler Natta polypropylene of the PPC is a virgin material. The term “virgin” as used herein denotes newly produced materials and/or objects prior to their first use, which have not already been recycled.

In an alternative aspect, the Ziegler Natta polypropylene of the PPC is a recycled polypropylene (rPP) for example a polypropylene sourced from recycled polymer waste. Herein the term “recycled polymer waste” is used to indicate a polymer material recovered from either post-consumer waste or industrial waste, as opposed to virgin polymers. In one or more aspects, the rPP is obtained from recycled polymer waste. Herein the term “recycled polymer waste” is used to indicate a polymer material recovered from either post-consumer waste or post-industrial waste, as opposed to virgin polymers. In one or more aspects, the rPP is a Post-Consumer Recycled resin or PCR. In one or more aspects, the rPP is a Post-Industrial Recycled resin or PIR. PCR is obtained from objects having completed at least a first use cycle (or life cycle), i.e. having already served their first purpose; while PIR refers to resin obtained from manufacturing scrap, which has not normally reached a consumer. It is to be understood that a recycled polypropylene may comprise polypropylene sourced from any number of sources and consequently will contain polypropylene prepared with any number of differing catalysts. For example, the recycled polypropylene may contain a combination of Ziegler Natta catalyzed resin and metallocene catalyzed resin.

A primary polypropylene suitable for use in this disclosure (e.g., recycled polypropylene or virgin polypropylene) may have a density, as determined in accordance ASTM D1505, of from about 0.895 grams per cubic centimeter (g/cc) to about 0.920 g/cc, additionally or alternatively, from about 0.900 g/cc to about 0.915 g/cc or, additionally or alternatively, from about 0.905 g/cc to about 0.915 g/cc. In one or more aspects, a primary polypropylene suitable for use in this disclosure may have a melt-mass flow rate, as determined in accordance with ASTM D1238, of from about 5 decigrams per minute (dg/min.) to about 150 dg/min., additionally or alternatively from about 10 dg/min. to about 100 dg/min., additionally or alternatively from about 10 dg/min. to about 40 dg/min. In an aspect, a primary polypropylene suitable for use in this disclosure may have a flexural modulus, as determined in accordance with ASTM D790, of from about 100,000 pounds per square inch (psi) to about 300,000 psi, additionally or alternatively from about 100,000 psi to about 250,000 psi, additionally or alternatively from about 120,000 psi to about 220,000 psi. In an aspect, a primary polypropylene suitable for use in this disclosure may have a tensile yield strength, as determined in accordance with ASTM D638, of from about 2,000 psi to about 6,000 psi, additionally or alternatively from about 2,000 psi to about 5,000 psi, additionally or alternatively from about 3,000 psi to about 4,000 psi. In an aspect, a primary polypropylene suitable for use in this disclosure may have an Izod impact, as determined in accordance with ASTM D-256, of from about 0.5 ft-lb/in to about 6.0 ft-lb/in, additionally or alternatively from about 1.0 ft-lb/in to about 5.0 ft-lb/in, additionally or alternatively from about 1.0 ft-lb/in to about 4.0 ft-lb/in

In one or more aspects, the secondary polypropylene of the PPC is a metallocene-catalyzed polypropylene. Metallocene catalysts refer to coordination compounds incorporating one or more cyclopentadienyl (Cp) groups (which may be substituted or unsubstituted, each substitution being the same or different) coordinated with a transition metal. The substituent groups on Cp may be linear, branched or cyclic hydrocarbyl radicals, for example. The inclusion of cyclic hydrocarbyl radicals may transform the Cp into other contiguous ring structures, such as indenyl, azulenyl and fluorenyl groups, for example. These contiguous ring structures may also be substituted or unsubstituted by hydrocarbyl radicals, such as C₁ to C₂₀ hydrocarbyl radicals, for example.

The metal atom “M” of the metallocene catalyst compound may be selected from Groups 3 through 12 atoms and lanthanide Group atoms, or from Groups 3 through 10 atoms or from Sc, Ti, Zr, Hf, V, Nb, Ta, Mn, Re, Fe, Ru, Os, Co, Rh, Ir and Ni. The oxidation state of the metal atom “M” may range from 0 to +7 or is +1, +2, +3, +4 or +5, for example. The bulky ligand generally includes a cyclopentadienyl group (Cp) or a derivative thereof The Cp ligands are distinct from the leaving groups bound to the catalyst compound in that they are not highly susceptible to substitution/abstraction reactions.

Examples of polypropylene prepared through the use of metallocene catalysts are described in further detail in U.S. Pat. Nos. 5,158,920, 5,416,228, 5,789,502, 5,807,800, 5,968,864, 6,225,251, 6,777,366, 6,777,367, 6,579,962, 6,468,936, 6,579,962 and 6,432,860, each of which is incorporated by reference herein.

In one or more aspects, the secondary polypropylene of the PPC is characterized by a density, as determined in accordance with ASTM D1505, of from about 0.890 g/cc to about 0.965 g/cc additionally or alternatively from about 0.895 g/cc to about 0.945 g/cc additionally or alternatively from about 0.895 g/cc to about 0.925 g/cc. In one or more aspects, the secondary polypropylene by a weight average molecular weight (Mw) of ranging from about 100,000 g/mol to about 500,000 g/mol, additionally or alternatively from about 100,000 g/mol to about 400,000 g/mol additionally or alternatively from about 150,000 g/mol to about 300,000 g/mol. Furthermore, the secondary polypropylene according to the present disclosure can have a relatively narrow molecular weight distribution measured by gas phase chromatography. For example, the secondary propylene may have a molecular weight distribution of less than about 4.0, additionally or alternatively less than about 3.8, or, additionally or alternatively, less than about 3.5. The secondary polypropylene may have a melt flow rate (MFR) as determined in accordance with ASTM D1238 of from about 1.0 dg/min. to about 150 dg/min., additionally or alternatively from about 5.0 dg/min. to about 100 dg/min., additionally or alternatively from about 10 dg/min. to about 50 dg/min. In one or more aspects, the secondary polypropylene when formed into a specimen has a tensile modulus, as determined in accordance with ASTM D638, of from about 100,000 psi to about 300,000 psi, additionally or alternatively from about 100,000 psi to about 250,000 psi, additionally or alternatively from about 120,000 psi to about 220,000 psi.

In one or more aspects, the recycled polypropylene fraction of the PPC comprises isotactic propylene homopolymers, random copolymers of propylene with ethylene and/or C₄-C₈ α-olefins, heterophasic copolymers comprising a propylene homopolymer and/or at least one C₂ or C₄-C₈ α-olefin copolymer, an elastomeric fraction comprising copolymers of ethylene with propylene, a C₄-C₈ α-olefin, minor amounts of a diene or combinations thereof. Herein “isotactic polypropylene homopolymers” refers to a stereoregular form of polypropylene where all of its pendant groups are arranged on the same side of the polymer chain and “heterophasic copolymers refer to a combination of a crystalline polypropylene matrix with embedded particles of an ethylene-propylene rubbers and polyethylene.

In one or more aspects, the primary polypropylene is present in the PPC in an amount ranging from about 0.1 weight percent (wt. %) to about 99 wt. %, additionally or alternatively from about 50 wt. % to about 80 wt. %, additionally or alternatively from about 50 wt. % to about 70 wt. % and the secondary polypropylene is present in the PPC in an amount ranging from about 1 wt. % to about 100 wt. %, additionally or alternatively from about 10 wt. % to about 50 wt. %, additionally or alternatively from about 30 wt. % to about 50 wt. % based on the total weight of the PPC.

In one or more aspects, the PPC further comprises an elastomer (rubber). Examples of elastomers suitable for inclusion in the PPC include without limitation 1,3-butadiene, 2-methyl-1,3-butadiene, 2-chloro-1,3 butadiene, 2-methyl-1,3-butadiene, and 2-chloro-1,3-butadiene. In an aspect, the elastomer comprises an aliphatic conjugated diene monomer. Without limitation, examples of aliphatic conjugated diene monomers suitable for use in the present disclosure include C₄ to C₉ dienes such as butadiene monomers. Blends or copolymers of the diene monomers may also be used. Likewise, mixtures or blends of one or more elastomers may be used. In an aspect, the elastomer comprises a homopolymer of a diene monomer, alternatively, the elastomer comprises polybutadiene. In an aspect, the elastomer may be present in the PPC in amounts ranging from about 0 wt. % to about 30 wt. %, additionally or alternatively from about 5 wt. % to about 20 wt. %, additionally or alternatively from about 5 wt. % to about 15 wt. % based on the total weight of the PPC.

In one or more aspects, the primary and/or secondary polypropylene contain additives to impart desired physical properties, such as printability, increased gloss, or a reduced blocking tendency. Examples of additives include without limitation stabilizers, ultra-violet screening agents, oxidants, anti-oxidants, anti-static agents, ultraviolet light absorbents, fire retardants, processing oils, mold release agents, coloring agents, pigments/dyes, fillers, and/or other additives known to one skilled in the art. The aforementioned additives may be used either singularly or in combination to form various formulations of the polymer.

A polypropylene suitable for use in the present disclosure may be formed by placing propylene alone in a suitable reaction vessel in the presence of a catalyst (e.g., Ziegler-Natta, metallocene) and under suitable reaction conditions for polymerization thereof. Standard equipment and processes for polymerizing the propylene into a polymer are known to one skilled in the art. Such processes may include solution phase, gas phase, slurry phase, bulk phase, high pressure processes, or combinations thereof.

In one or more aspects, the polypropylene is formed by a gas phase polymerization process. One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from 100 pounds per square inch gauge (psig) to 500 psig, additionally or alternatively from 200 psig to 400 psig, additionally or alternatively from 250 psig to 350 psig. The reactor temperature in a gas phase process may vary from 30° C. to 120° C., additionally or alternatively from 60° C. to 115° C., additionally or alternatively from 70° C. to 110° C., or from 70° C. to 95° C.

In one or more aspects, the polypropylene is formed by a slurry phase polymerization process. Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutene). The medium employed is generally liquid under the conditions of polymerization and relatively inert. A bulk phase process is similar to that of a slurry process. However, a process may be a bulk process, a slurry process or a bulk slurry process.

In one or more aspects, the PPC may be used to form an injection molded article. In injection molding, resin pellets (granules) are poured into a feed hopper which is a large open bottomed container that feeds the granules down to a screw. The screw is turned by a hydraulic or electric motor that turns the screw feeding the pellets up the screw's grooves. The depths of the screw flights decrease towards the end of the screw nearest the mold. As the screw rotates, the pellets are moved forward in the screw which undergoes extreme pressure and friction generating most of the heat needed to melt the pellets. Heaters on either side of the screw assist in the heating and temperature control around the pellets during the melting process to from a liquid resin. The screw travel limit switches set the distance the screw moves.

The liquid resin is then injected into a mold. Since the molds are clamped shut by the hydraulics, the heated plastic is forced under the pressure of the injection screw to take the shape of the mold. Water-cooling channels then assist in cooling the mold and the heated plastic solidifies into the part. The cycle is completed when the mold opens and the part is ejected (with the assistance of ejector pins within the mold).

In one or more aspects, an article prepared by injection molding utilizing a PPC may display weld lines with a strength ranging from about 1000 psi to about 5000 psi, additionally or alternatively from about 1500 psi to about 4000 psi additionally or alternatively from about 2000 psi to about 3000 psi.

The present disclosure describes (1) polypropylene resin with superior weld line strengths for injection molding applications; (2) films made from the polypropylene resin with superior weld strength and (3) use of metallocene polypropylene to improve weld line strengths of Ziegler-Natta polypropylene or polymer formulations containing recycled polypropylene. For example, a metallocene polypropylene resin, such as the secondary polypropylene disclosed herein, may have a relatively narrower molecular weight distribution when compared with a Ziegler-Nata polypropylene, such as the primary polypropylene disclosed herein. Not intending to be bound by theory, the more uniform molecular lengths enable the relatively longer molecules of the polymer to form entanglements more efficiently when two melt fronts meet during injection molding, resulting in superior weld line strengths. Addition of small amounts of C₂-C₄, C₂-C₆ and C₂-C₈ rubbers can further improve the weld line strength, resulting in improved mechanical properties. Molded articles prepared from a PPC of the type disclosed herein are characterized by weld lines with improved physical properties such as increased mechanical strength. When weld lines are present, the overall mechanical strength of the molded articles may be determined, at least in part, by the strength of the weld line. By using the PPC of the present disclosure, the overall strength of the molded article can be increased by increasing the strength of the weld line. For example, the molded articles made using the PPC of the present disclosure may have a mechanical strength that is increased by equal to or greater than about 10%, alternatively equal to or greater than about 25%, or alternatively equal to or greater than about 50%, compared to molded articles made lacking a metallocene polypropylene.

### ADDITIONAL DISCLOSURE

A first aspect which is a polymer blend comprising (i) a primary polypropylene; and (ii) a secondary polypropylene, wherein the primary polypropylene comprises a Ziegler Natta polypropylene, a recycled polypropylene or combination thereof, and wherein the secondary polypropylene comprises a metallocene-catalyzed polypropylene.

A second aspect which is the polymer blend of the first aspect wherein the primary polypropylene is a virgin Ziegler Natta catalyzed polymer.

A third aspect which is the polymer blend of any of the first through second aspects wherein the primary polypropylene is a recycled polypropylene,

A fourth aspect which is the polymer blend of the third aspect wherein the recycled polypropylene is sourced from recycled polymer waste.

A fifth aspect which is the polymer blend of the fourth aspect wherein the recycled polymer waste comprises post-consumer recycled resin, post-industrial recycled resin or combinations thereof.

A sixth aspect which is the polymer blend of any of the first through fifth aspects wherein the recycled polypropylene comprises isotactic propylene homopolymers, random copolymers of propylene with ethylene and/or C4-C8 α-olefins, heterophasic copolymers comprising a propylene homopolymer and/or at least one C2 or C4-C8 α-olefin copolymer, an elastomeric fraction comprising copolymers of ethylene with propylene, a C4-C8 α-olefin, minor amounts of a diene or combinations thereof.

A seventh aspect which is the polymer blend of any of through first through sixth aspects wherein the primary polypropylene has a density of from about 0.895 g/cc to about 0.920 g/cc.

An eighth aspect which is the polymer blend of any of the first through seventh aspects wherein the primary polypropylene has a melt mass flow rate of from about 5 dg/min. to about 150 dg/min.

A ninth aspect which is the polymer blend of any of the first through eighth aspects wherein the primary polypropylene when formed into a specimen has a tensile modulus of from about 100,000 psi to about 300,000 psi.

A tenth aspect which is the polymer blend of any of the first through ninth aspects wherein the secondary polypropylene is characterized by a density of from about 0.890 g/cc to about 0.965 g/cc.

An eleventh aspect which is the polymer blend of any of the first through tenth aspects wherein the secondary polypropylene is characterized by a weight average molecular weight a ranging from about 100,000 g/mol to about 500,000 g/mol.

A twelfth aspect which is the polymer blend of any of the first through eleventh aspects wherein the secondary polypropylene is characterized by a molecular weight distribution of less than about 4.

A thirteenth aspect which is the polymer blend of any of the first through twelfth aspects wherein the secondary polypropylene has a melt mass flow rate of from about 1 dg/min. to about 150 dg/min.

A fourteenth aspect which is the polymer blend of any of the first through thirteenth aspects wherein the secondary polypropylene when formed into a specimen has a flexural modulus of from about 100,000 psi to about 300,000 psi.

A fifteenth aspect which is the polymer blend of any of the first through fourteenth aspects further comprising an elastomer.

A sixteenth aspect which is the polymer blend of the thirteenth aspect wherein the elastomer comprises 1,3-butadiene, 2-methyl-1,3-butadiene, 2-chloro-1,3 butadiene, 2-methyl-1,3-butadiene, 2-chloro-1,3-butadiene or combinations thereof.

A seventeenth aspect which is the polymer blend of any of the first through sixteenth aspects wherein the primary polypropylene is present in the PPC in an amount ranging from about 0.1 wt. % to about 99 wt. %.

An eighteenth aspect which is the polymer blend of any of the first through seventeenth aspects wherein the secondary polypropylene is present in the PPC in an amount ranging from about 1 wt. % to about 99 wt. %.

A nineteenth aspect which is the injection molded article comprising weld lines prepared from the polymer blend of claim 1.

A twentieth aspect which is the injection molded article of the nineteenth aspect wherein the weld lines are characterized by a strength of from about 1000 psi to about 5000 psi.

### EXAMPLES

The aspects having been generally described, the following examples are given as particular aspects of the disclosure and to demonstrate the practice and advantages thereof. It is understood that the examples are given by way of illustration and are not intended to limit the specification of the claims in any manner.

### Example 1

The effect of using a PPC of the type disclosed herein on the mechanical properties of molded articles was investigated. Two compounds were produced based on a polypropylene homopolymer with 30 wt. % of a polypropylene recovered from PIR (rPP). For each sample, one large batch was produced on a twin screw extruder (TSE), and the other smaller batch was produced on a single screw extruder (SSE). Three formulations were evaluated; a virgin polypropylene impact copolymer designated 5720WZ; a rPP that was a blend of the 5720WZ and 30% of rPP prepared on a TSE; and a rPP that was a blend of the 5720WZ and 30% of rPP prepared on a SSE. 5720 WZ is an impact copolymer polypropylene commercially available from TotalEnergies.

The tensile mechanical properties of the compounds are listed in Table 1. As the recycled polypropylene had a lower stiffness, the resulting hybrid rPP compounds demonstrated lower stiffness as well. No major difference was obtained for the same formulation produced on SSE and TSE.

TABLE 1

| | | Base Resin + | Base Resin + |
|---|---|---|---|
| | | 30 wt. % PIR | 30 wt. % PIR |
| | Base | (twin screw | (single screw |
| Property | Resin | extruder) | extruder) |
| MFR | 20.3 | 20.4 | 20.8 |
| Tensile modulus | 190 | 176 | 170 |
| (kpsi) | | | |
| Tensile yield | 3387 | 3251 | 3206 |
| strength (psi) | | | |
| Tensile break | 2423 | 2224 | 2163 |
| strength (psi) | | | |
| Elongation at | 4 | 4.6 | 4.6 |
| yield (%) | | | |
| Elongation at | 93 | 91 | 80 |
| break (%) | | | |

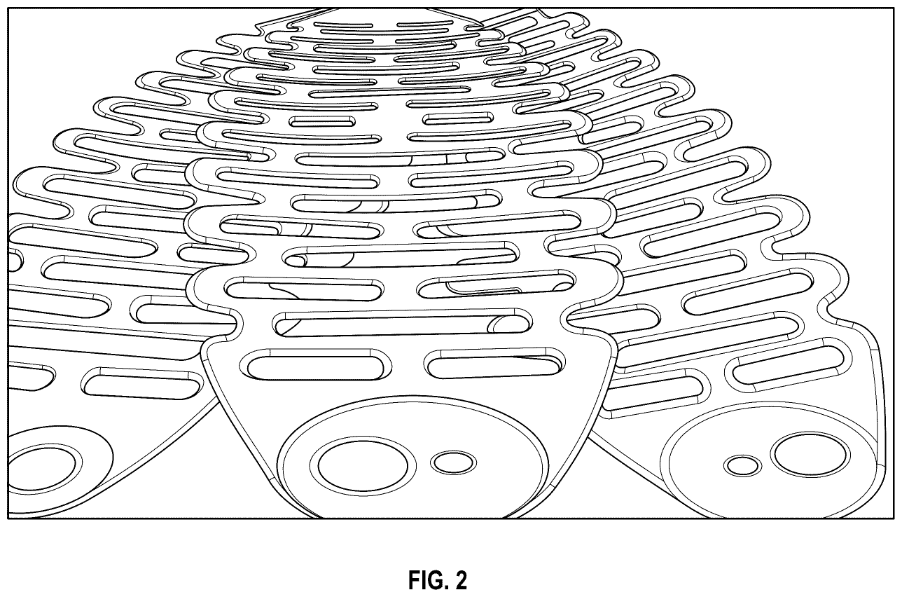

The formulations were subjected to injection molding evaluations. The molded part is shown in FIG. 2. Based on the evaluations, the molded part made with the polymer blend performed even better than a molded part made with virgin polypropylene homopolymer. Upon close observation of the part, it was obvious that multiple weld lines were formed during injection molding of the part. In other words, the data suggests that the hybrid formulations resulted in enhanced weld line strengths over standard virgin polypropylene homopolymer. The recycled polymer in the hybrid formulation was further analyzed and determined to primarily constitute metallocene homopolymer polypropylene. It was believed that the narrow molecular weight distribution of the metallocene resin was able to effectively reinforce the homopolymer weld line, which was likely the major contributor to the superior performance observed.

### Example 2

The weld line strength of hybrid polymer formulations comprising a rPP was compared to that of a base resin. Injection-molding bars were produced with weld lines formed under varying molding pressures ranging from 600 psi to 2000 psi. All samples were systematically tested according to identical analytical procedures.

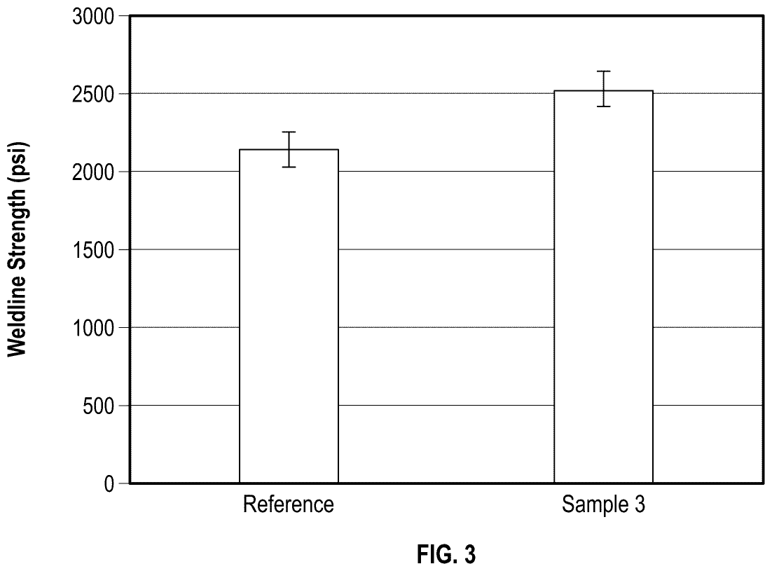

Results indicate that at elevated molding pressure, the hybrid formulations demonstrated comparable weld line performance to 5720WZ. Interestingly, at lower molding pressure (i.e., 600 psi). Hybrid formulations exhibited relatively higher weld line strength (approximately 15% improvement) when compared to 5720WZ. The base resin used in the formulation was 5720 WZ which was compared to sample 3 of Example 1 as exemplified in FIG. 3. After comprehensive composition analysis, it was found that the rPP utilized comprised metallocene PP and a certain amount of elastomer. Literature studies have showed that a narrower molecular weight distribution (MWD) of PP results in superior weld line strength, contributed to higher molecular entanglement density at the interface. The additional elastomer may generate a beneficial synergistic effect for further enhancement of weld line properties. The PIR molecules with narrower MWD (˜3.3 MWD per GPC analysis) in the hybrid compounds were found to facilitate more efficient chain entanglement, leading to enhanced weld line strength. Although the improvement in a single weld line is not significantly large, it's expected to generate a magnified effect when applied to final parts involving sophisticated weld lines.

While various aspects have been shown and described, modifications thereof can be made by one skilled in the art without departing from the spirit and teachings of the disclosure. The aspects described herein are exemplary only, and are not intended to be limiting. Many variations and modifications of the aspects disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects disclosed herein. The discussion of a reference herein is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A polymer blend, comprising:
(i) a primary polypropylene comprising a Ziegler Natta polypropylene, a recycled polypropylene, or a combination thereof; and
(ii) a secondary polypropylene comprising a metallocene-catalyzed polypropylene.

2. The polymer blend of claim 1, wherein the primary polypropylene is a virgin Ziegler Natta catalyzed polymer.

3. The polymer blend of claim 1, wherein the primary polypropylene is a recycled polypropylene,

4. The polymer blend of claim 3, wherein the recycled polypropylene is sourced from recycled polymer waste.

5. The polymer blend of claim 4, wherein the recycled polymer waste comprises post-consumer recycled resin, post-industrial recycled resin or combinations thereof.

6. The polymer blend of claim 1, wherein the recycled polypropylene comprises isotactic propylene homopolymers, random copolymers of propylene with ethylene and/or C₄-C₈ α-olefins, heterophasic copolymers comprising a propylene homopolymer and/or at least one C₂ or C₄-C₈ α-olefin copolymer, an elastomeric fraction comprising copolymers of ethylene with propylene, a C₄-C₈ α-olefin, minor amounts of a diene or combinations thereof.

7. The polymer blend of claim 1, wherein the primary polypropylene has a density of from about 0.895 g/cc to about 0.920 g/cc.

8. The polymer blend of claim 1, wherein the primary polypropylene has a melt mass flow rate of from about 5 dg/min. to about 150 dg/min.

9. The polymer blend of claim 1, wherein the primary polypropylene when formed into a specimen has a tensile modulus of from about 100,000 psi to about 300,000 psi.

10. The polymer blend of claim 1, wherein the secondary polypropylene is characterized by a density of from about 0.890 g/cc to about 0.965 g/cc.

11. The polymer blend of claim 1, wherein the secondary polypropylene is characterized by a weight average molecular weight a ranging from about 100,000 g/mol to about 500,000 g/mol.

12. The polymer blend of claim 1, wherein the secondary polypropylene is characterized by a molecular weight distribution of less than about 4.

13. The polymer blend of claim 1, wherein the secondary polypropylene has a melt mass flow rate of from about 1 dg/min. to about 150 dg/min.

14. The polymer blend of claim 1, wherein the secondary polypropylene when formed into a specimen has a flexural modulus of from about 100,000 psi to about 300,000 psi.

15. The polymer blend of claim 1, further comprising an elastomer.

16. The polymer blend of claim 13, wherein the elastomer comprises 1,3-butadiene, 2-methyl-1,3-butadiene, 2-chloro-1,3 butadiene, 2-methyl-1,3-butadiene, 2-chloro-1,3-butadiene or combinations thereof.

17. The polymer blend of claim 1, wherein the primary polypropylene is present in the PPC in an amount ranging from about 0.1 wt. % to about 99 wt. %.

18. The polymer blend of claim 1, wherein the secondary polypropylene is present in the PPC in an amount ranging from about 1 wt. % to about 99 wt. %.

19. An injection molded article comprising weld lines prepared from the polymer blend of claim 1.

20. The injection molded article of claim 19, wherein the weld lines are characterized by a strength of from about 1000 psi to about 5000 psi.
